(19) United States
(12) Patent Application Publication
(10) Pub. No.: US 2018/0199292 A1
(43) Pub. Date: Jul. 12, 2018

(54) Fabric Wise Width Reduction

(71) Applicant: Mellanox Technologies TLV Ltd., Raanana (IL)

(72) Inventors: Liron Mula, Ramat Gan (IL); Lavi Koch, Tel Aviv (IL); Gil Levy, Hod Hasharon (IL); Aviv Kfir, Nili (IL); Benny Koren, Zichron Yaakov (IL)

(21) Appl. No.: 15/401,042

(22) Filed: Jan. 8, 2017

(51) Int. Cl. H04W 52/24; H04W 72/04; H04L 12/44

(52) U.S. Cl. CPC H04W 52/248; H04W 72/0446; H04W 72/042; H04W 72/0413; H04L 12/44

(57) ABSTRACT

Power consumption is controlled in a fabric of interconnected network switches in which there are queues for data awaiting transmission through the fabric and a plurality of lanes for carrying the data between ports of the switches, A bandwidth manager iteratively determines current queue byte sizes, and assigns respective bandwidths to the switches according to the current queue byte sizes. Responsively to the assigned bandwidths, the bandwidth manager causes a portion of the lanes of the switches to be disabled so as to maintain a power consumption of the fabric below a predefined limit.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

### 1. Field of the Invention

This invention relates to transmission of digital information over data networks. More particularly, this invention relates to power management in switched data networks.

### 2. Description of the Related Art

Various methods are known in the art for reducing the power consumption of a communication link or network by reducing unneeded data capacity. For example, U.S. Pat. No. 6,791,942, whose disclosure is incorporated herein by reference, describes a method for reducing power consumption of a communications interface between a network and a processor. The method monitors data traffic from the sides of the interface. Upon detecting a predetermined period of no data traffic on both sides, the method disables an auto-negotiation mode of the interface and forces the interface to operate at its lowest speed.

As another example, U.S. Pat. No. 7,584,375, whose disclosure is incorporated herein by reference, describes a distributed power management system for a bus architecture or similar communications network. The system supports multiple low power states and defines entry and exit procedures for maximizing energy savings and communication speed.

Chiaraviglio et al. analyze another sort of approach in “Reducing Power Consumption in Backbone Networks,” Proceedings of the 2009 IEEE International Conference on Communications (ICC 2009, Dresden, Germany, June, 2009), which is incorporated herein by reference. The authors propose an approach in which certain network nodes and links are switched off while still guaranteeing full connectivity and maximum link utilization, based on heuristic algorithms. They report simulation results showing that it is possible to reduce the number of links and nodes currently used by up to 30% and 50%, respectively, during off-peak hours while offering the same service quality.

Commonly assigned U.S. Pat. No. 8,570,865, which is herein incorporated by reference, describes power management in a fat-tree network. Responsively to an estimated characteristic, a subset of spine switches in the highest level of the network is selected, according to a predetermined selection order, to be active in carrying the communication traffic. In each of the levels of the spine switches below the highest level, the spine switches to be active are selected based on the selected spine switches in a next-higher level. The network is operated so as to convey the traffic between leaf switches via active spine switches, while the spine switches that are not selected remain inactive.

### SUMMARY OF THE INVENTION

Current fabric switches have a predetermined number of internal links. Conventionally, once the fabric power-budget is set, the number of active links is never changed. Thus, the throughput of the system is bound by the max-cut-min-flow law, which can be derived from the well-known Ford-Fulkerson method for computing the maximum flow in a network. In practice, the traffic flow corresponding to the max-cut in the fabric is almost never achieved, since network traffic is not evenly distributed. For example, an inactive link is sometimes needed in order to gain a better temporal max-cut.

According to disclosed embodiments of the invention, a fine-grained method of power control within a maximal power usage is achieved by dynamically managing the bandwidth carried by internal links in the fabric. A bandwidth manager executes a dynamic feature called “width-reduction”. This feature enables a link to operate at different bandwidths. By limiting the bandwidth of a link, the bandwidth manager effectively throttles the power consumed by that link. From time to time the bandwidth manager decides which links should be active, and at which bandwidths. By employing width reduction it is possible to obtain a higher throughput for a given power level than by maintaining a static bandwidth assignment.

There is provided according to embodiments of the invention a method for communication, which is carried out in a fabric of interconnected network switches having ingress ports and egress ports, a plurality of lanes for carrying data between the egress port of one of the switches and the ingress port of another of the switches, and queues for data awaiting transmission via the egress ports, iteratively at allocation intervals. The method includes determining current queue byte sizes of the queues of the switches, assigning respective bandwidths to the switches according to the current queue byte sizes thereof, and responsively to the assigned respective bandwidths disabling a portion of the lanes of the switches to maintain a power consumption of the fabric below a predefined limit.

According to one aspect of the method, an aggregate of the assigned respective bandwidths complies with bandwidth requirements of leaf nodes of the fabric.

According to a further aspect of the method, the aggregate of the assigned respective bandwidths does not exceed throughput requirements of leaf nodes of the fabric.

According to yet another aspect of the method, in assigning respective bandwidths larger bandwidths are assigned to switches that have long queue byte sizes relative to switches that have short queue byte sizes.

According to still another aspect of the method, in disabling the lanes fewer lanes of the switches that have long queue byte sizes are disabled relative to the switches that have short queue byte sizes.

According to an additional aspect of the method, uplinks through the fabric have a different bandwidth than downlinks through the fabric.

There is further provided according to embodiments of the invention an apparatus, including a fabric of interconnected network switches, a bandwidth manager connected to the switches, ingress ports and egress ports in the switches. The ports provide a plurality of lanes for carrying data between the egress port of one of the switches and the ingress port of another of the switches. A memory in the switches stores queues for data awaiting transmission via the egress ports. The bandwidth manager is operative, iteratively at allocation intervals, for determining current queue byte sizes of the queues of the switches, assigning respective bandwidths to the switches according to the current queue byte sizes thereof, and responsively to the assigned respective bandwidths disabling a portion of the lanes of the switches to maintain a power consumption of the fabric below a predefined limit.

According to another aspect of the apparatus, the egress ports comprise a plurality of serializers that are commonly served by one of the queues.

### BRIEF DESCRIPTION OF THE SEVERAL VIEWS OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a diagram that schematically illustrates a network in which a power reduction scheme is implemented in accordance with an embodiment of the present invention;

FIG. 2 is a detailed block diagram of a portion of a fabric in accordance with an embodiment of the invention;

FIG. 3 is a block diagram illustrating details of a switch in the fabric shown in FIG. 2 in accordance with an embodiment of the invention;

FIG. 4 is a flow chart of a method of managing bandwidth in a fabric to comply with a power limitation in accordance with an embodiment of the invention; and

FIG. 5 is a graph illustrating the effect of the bandwidth allocation interval on packet drop under varying traffic conditions.

### DETAILED DESCRIPTION OF THE INVENTION

In the following description, numerous specific details are set forth in order to provide a thorough understanding of the various principles of the present invention. It will be apparent to one skilled in the art, however, that not all these details are necessarily always needed for practicing the present invention. In this instance, well-known circuits, control logic, and the details of computer program instructions for conventional algorithms and processes have not been shown in detail in order not to obscure the general concepts unnecessarily.

Documents incorporated by reference herein are to be considered an integral part of the application except that, to the extent that any terms are defined in these incorporated documents in a manner that conflicts with definitions made explicitly or implicitly in the present specification, only the definitions in the present specification should be considered.

### Definitions

A “switch fabric” or “fabric” refers to a network topology in which network nodes interconnect via one or more network switches (such as crossbar switches), typically through many ports. The interconnections are configurable such that data is transmitted from one node to another node via designated ports. A common application for a switch fabric is a high performance backplane.

A “fabric facing link” is a network link in a fabric that is configured for transmission to or from one network element to another network element in the fabric.

### System Overview.

Reference is now made to FIG. 1, which is a diagram that schematically illustrates a network in which a power management scheme is implemented in accordance with an embodiment of the present invention. Network 20 comprises multiple computing nodes 22, each of which typically comprises one or more processors with local memory and a communication interface (not shown), as are known in the art. Computing nodes 22 are interconnected, for example in an Infini-Band™/℠ or Ethernet switch fabric. Network 20 and comprises leaf switches 26, at the edge of the network, which connect directly computing nodes 22, and spine switches 28, through which the leaf switches 26 are interconnected. The leaf and spine switches are connected by links (shown in the figures that follow) in any suitable topology. The principles of the invention are agnostic as to topology. Data communication within the network 20 is conducted by high-speed serial transmission.

A bandwidth manager 29 controls aspects of the operation of switches 26, 28, such as routing of messages through network 20, performing any necessary arbitration, and remapping of inputs to outputs. Routing issues typically relate to the volume of the traffic and the bandwidth required to carry the traffic, which may include either the aggregate bandwidth or the specific bandwidth required between various pairs of computing nodes (or both aggregate and specific bandwidth requirements). Additionally or alternatively, other characteristics may be based, for example, on the current traffic level, traffic categories, quality of service requirements, and/or on scheduling of computing jobs to be carried out by computing nodes that are connected to the network. Specifically, for the purposes of embodiments of the present invention, the bandwidth manager 29 is concerned with selection of the switches and the control of links between the switches for purposes of power management, as explained in further detail hereinbelow.

The bandwidth manager 29 may be implemented as a dedicated processor, with memory and suitable interfaces, for carrying out the functions that are described herein in a centralized fashion. This processor may reside in one (or more) of computing nodes 22, or it may reside in a dedicated management unit. In some embodiments, communication between the bandwidth manager 29 and the switches 26, 28 may be carried out through an out-of-band channel and does not significantly impact the bandwidth of the fabric nor that of individual links.

Alternatively or additionally, although bandwidth manager 29 is shown in. FIG. 1, for the sake of simplicity, as a single block within network 20, some or all of the functions of this manager may be carried out by distributed processing and control among leaf switches 26 and spine switches 28 and/or other elements of network 20. The term “bandwidth manager,” as used herein, should therefore be understood to refer to a functional entity, which may reside in a single physical entity or be distributed among multiple physical entities.

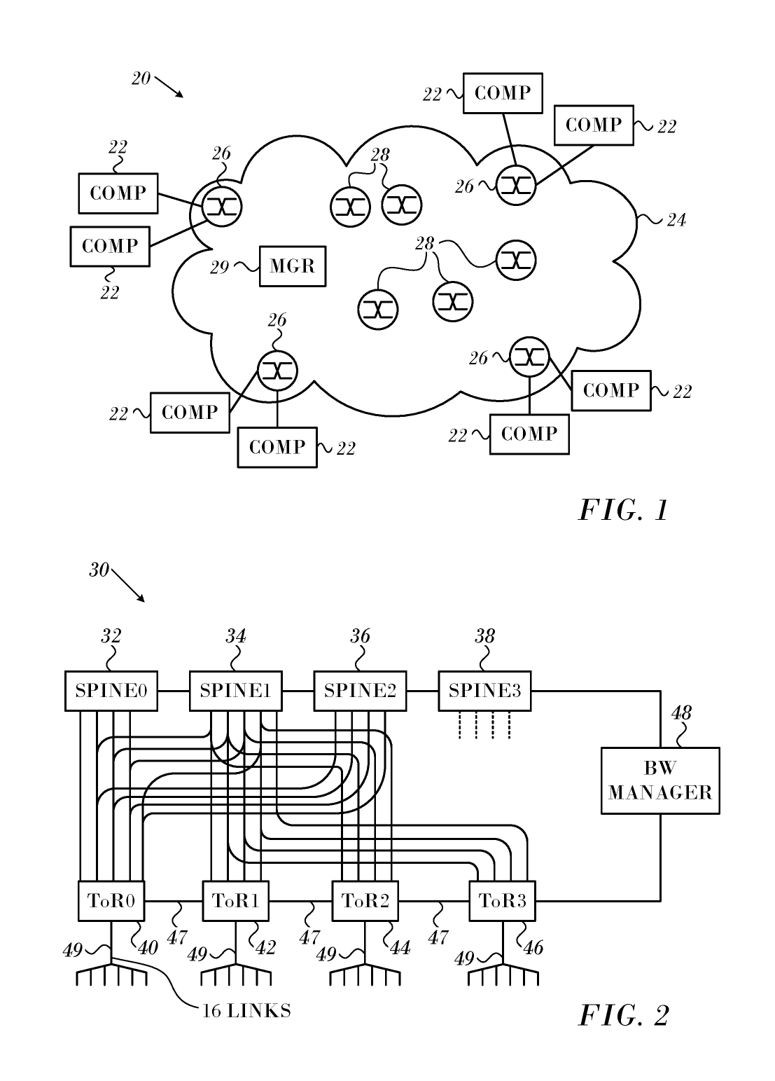

Reference is now made to FIG. 2, which is a detailed block diagram of a portion of a fabric 30, in accordance with an embodiment of the invention. Shown are four spine nodes 32, 34, 36, 38, four leaf nodes 40, 42, 44, 46 and a bandwidth manager 48. Multiple links 49 (16 links in the example of FIG. 2) carry outflow data from the leaf nodes 40, 42, 44, 46. The leaf and spine switches can be implemented, for example, as crossbar switches, which enable reconfiguration of the fabric 30 under control of the bandwidth manager 48, functioning, inter aim as a bandwidth (BW) manager. Fabric reconfiguration is an operation that changes the available bandwidth of a link in a fabric, and has the effect of changing the power consumption of the link. One way of achieving fabric reconfiguration is taught in commonly assigned U.S. Patent Application Publication No. 2011/0173352, which is herein incorporated by reference.

In one configuration, spine node 34 is set to connect with leaf node 44, while in other configurations the connection between spine node 34 and leaf node 44 is broken or blocked, and a new connection formed (or unblocked) between spine node 34 and any of the other leaf nodes 40, 42, 46.

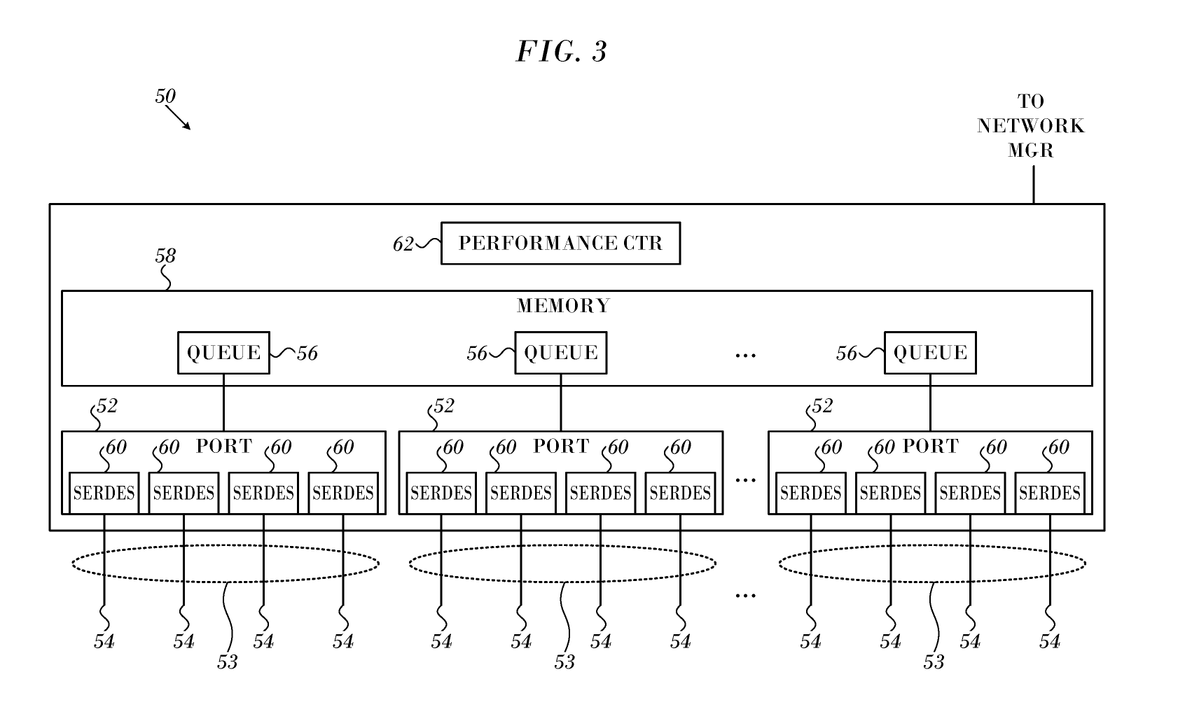

Reference is now made to FIG. 3, which is a block diagram illustrating details of a switch 50 in the fabric 30 (FIG. 2) in accordance with an embodiment of the invention. The switch 50 has any number of serial ports 52, each of which transmits or accepts data via link 53 that comprise a plurality of lanes 54. In the example of FIG. 3 there are four lanes 54. The ports 52 are typical of a 40 Gb/s Ethernet fabric in which each of the four lanes transmits 10 Gb/s, but the principles of the invention are applicable, mutatis mutandis, to other fabrics and speeds, and to ports having different numbers of lanes. Each of the ports 52 has a respective data queue 56, all of which are implemented as buffers in a memory 58. Each of the queues 56 serves multiple Serializer/Deserializers, SERDES 60, e.g., four SERDES 60 in the example of FIG. 3. The queues 56 may be ingress queues or exit queues, according to the direction of data transmission with respect to the switch 50.

Each of the lanes 54 is connected to a respective SERDES 60, which can be operational or non-operational, independently of the other SERDES 60 in the port. Each SERDES 60 can be individually controlled directly or indirectly by command signals from the bandwidth manager 48 (FIG. 2) so as to activate or deactivate respective lanes 54. The term “deactivating,” as used in the context of the present patent application and in the claims, means that the lanes in question are functionally disabled. They are not used to communicate data during a given period of time, and can therefore be powered down (i.e., held in a low-power “sleep” state or powered off entirely). In the embodiments that are described hereinbelow the bandwidth manager 48 considers specific features of the network topology and/or scheduling of network use in order to individually activate or deactivate as many lanes as possible in selected switches in order to operate within a maximal level of power consumption while avoiding dropping packets.

Cumulative activity of the switch 50 during a time interval may be recorded by a performance counter 62, whose contents are accessible to the bandwidth manager.

### Power Management.

Continuing to refer to FIG. 2 and FIG. 3, The general scheme for power management in the fabric 30 is as follows:

The bandwidth manager 48 knows the state of all fabric-facing links, and knows the state of the queues 56 as well.

The bandwidth manager 48 assigns bandwidth for each fabric-facing link using a grading algorithm such that the fabric power-budget is not violated. Each switch responds to the bandwidth assignment by implementing its width-reduction features.

The links are configured such that a temporary max-cut of the fabric, which is computed according to current traffic, is maximized. For example, in FIG. 2, if all links 47 connecting the leaf nodes 40, 42, 44, 46 in the fabric 30 are operational at their maximum bandwidth (BW), than the max-cut, e.g., the traffic through the links 49 from leaf nodes 40, 42, 44, 46 is 16×BW. However, if some of the link 47 are operating at less than full bandwidth, i.e., a portion of their connecting lanes are disabled as a result of limitations in the power budget, there is no such guarantee.

The actual flow through the links 49 is the lesser of the flow requirement and the max-cut:

Min{max-cut[x−y],requirement[x−y]}.

The term “requirement” refers to a temporal requirement, i.e., the latency of the transit of the packet from x to y. The goodput through the fabric is the sum of all the flows through the links of the leaf nodes 40-46. The bandwidth manager 48 attempts to maximize goodput by reducing max-cut [x−y], as much as possible, provided that the requirement [x−y] does not exceed max-cut [x−y].

The risk of local switch buffer overflow is minimized (measured, for example by packet drop). In general, the bandwidth manager 48 attempts to estimate the bandwidth requirement (requirement [x−y]) for the fabric by sorting the queues of the switches according to space used. A switch with a high buffer usage (hence, low free space), is relatively likely to drop packets. Such a switch should be allocated a relatively high amount of output bandwidth.

A link in the fabric connecting one of the spine nodes 32, 34, 36, 38 with one of the leaf nodes 40, 42, 44, 46 that has a non-zero transmit queue (TQ) size can initially transmit the entire bandwidth. This is the case regardless of the size of the queue (in bytes). However, a link with a relatively long queue (large byte size) can sustain full bandwidth transmission for a longer period than a link with a shorter queue (small byte size). Therefore, a link with a long queue deserves a relatively larger bandwidth allocation, and would have relatively few of its lanes disabled. This strategy minimizes unused operational bandwidth, and reduces packet drop, thereby simulating a fabric operating at full bandwidth.

Each switch periodically reports its status and alerts to the bandwidth manager 48.

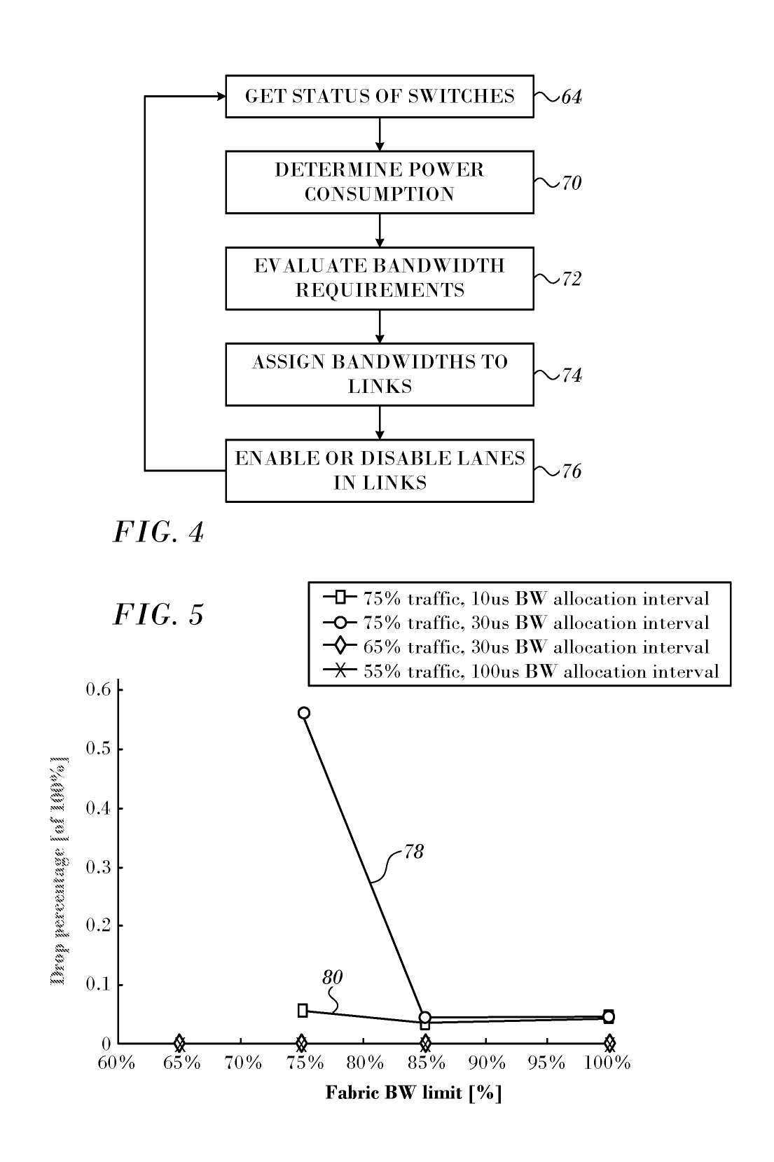

Reference is now made to FIG. 4, which is a flow chart of a method of managing bandwidth in a fabric to comply with a power limitation in accordance with an embodiment of the invention. The process steps are shown in a particular linear sequence in FIG. 4 for clarity of presentation. However, it will be evident that many of them can be performed in parallel, asynchronously, or in different orders. Those skilled in the art will also appreciate that a process could alternatively be represented as a number of interrelated states or events, e.g., in a state diagram. Moreover, not all illustrated process steps may be required to implement the method. For convenience of presentation, the process is described with reference to the preceding figures, it being understood that this is by way of example and not of limitation.

The process iterates in a loop. In step 64 the status of each link in the fabric is obtained by the bandwidth manager. In some embodiments the bandwidth manager may query the links using a dedicated channel. Alternatively the links may be programmed to automatically report their status to the bandwidth manager. The status of ingress and egress queues are obtained. The information may comprise the length of the queues, and the categories of traffic. Cumulative activity during a time interval may be obtained from performance counters in the switches. The pseudocode of Listing 1 illustrates one way of determining queue length in a fabric, incorporating a low pass filter to eliminate random “noise” in queue length measurement.

Listing 1

```
// (1) loop all switches and TQs
// collect queue length
  SwitchTqQueue[SwitchIdx].QueueLength[TqIdx] = (
    (1-alpha) * SwitchTqQueue[SwitchIndex].TqQueueLength[TqIdx] +
    (alpha) * CurrentSwitch.CurrentSwitchTq
    ) // sample new queue length, using a low-pass-filter
  SwitchTqQueue[SwitchIdx].TotalQueue +=
    SwitchTqQueue[SwitchIdx].QueueLength[TqIdx]
  };
TotalQueue += SwitchTqQueue[SwitchIdx].TotalQueue; //statistics
};
}
```

The fabric power consumption is measured in step 70 by suitable power metering devices. Alternatively, once the bandwidth is known, the fabric power consumption can be calculated from the number of active links and the queue. Normally the process of FIG. 4 executes continually in order to minimize power consumption. However, when the power consumption is well under the budgeted allocation, the algorithm may suspend until such time as the power consumption approaches or exceeds budget.

Next, at step 72 user-determined bandwidth requirements for the fabric during a current epoch are evaluated in relation to the computing jobs. In one approach to bandwidth assignment, the bandwidth manager may use network power conservation as a factor in deciding when to run each computing job. In general, the manager will have a list of jobs and their expected running times. Some of the jobs may have specific time periods (epochs) when they should run, while others are more flexible. As a rule of thumb, to reduce overall power consumption, the manager may prefer to run as many jobs as possible at the same time. On the other hand, the manager may consider the relation between the estimated traffic load and the maximal capabilities of a given set of spine switches, and if running a given job at a certain time will lead to an increase in the required number of active spine switches, the manager may choose to schedule the job at a different time. Further details of this approach are disclosed in commonly assigned U.S. Pat. No. 8,570,865, whose disclosure is herein incorporated by reference.

Next, at step 74 based on the assessment of step 72 respective bandwidths are assigned to switches in the fabric based on a sort order of the lengths of egress queues of the switches as described above.

Next, at step 76, based on the respective bandwidth assignments in step 74, logic circuitry in each link determines the number of lanes for its ports that are to be active, and enables or disables its links accordingly. For example, if a 40 Gb/s link in the example of FIG. 3 were assigned a bandwidth of 15 Gb/s, it could deactivate two of its 4 lanes. The link would operate at 20 Gb/s, thereby satisfying its bandwidth assignment. After performing step 76 and a predefined reporting interval has elapsed, control returns to step 64

The objective of steps 74, 76 is to disable as many lanes as possible without exceeding a threshold of data loss or packet drop, but remaining within the power budget. This enables the fabric to operate at minimal power while maintaining a required quality of service. Steps 74, 76 can be performed using the procedure in Listing 2, which represents a simulation. The power budget of the fabric is considered as fixed. The fabric must not violate the budget, even when there is a high packet drop count or poor quality of service.

Listing 2

// (1) limit to power budget
Number_TQ_100p_BW = NumTQs * (TargetBWPercentOf100 − 50) *
2 / 100
Number_TQ_75p_BW = (NumTQs − Number_TQ_100p_BW) / 3
Number_TQ_50p_BW = (NumTQs − Number_TQ_100p_BW) / 3
Number_TQ_25p_BW = (NumTQs − Number_TQ_100p_BW) / 3

In Listing 2, the variable NumTQs corresponds to the number of links in a simulated system. TargetBWPercentOf100 is a simulation parameter that describes the amount of traffic entering the fabric. A value of 75% bandwidth was used in the simulation. It should be noted that when 100% bandwidth is used for the parameter TargetBWPercentOf100, no bandwidth reduction can be accomplished, because all internal-facing links in the fabric are utilized.

```
// (2) sort all switches and TQs by queue length
// (3) assign new bandwidths acccording to sort order obtained in the setp
(2) BW
  1st [Number_TQ_100p_BW] TQs get 100%
  Then [Number_TQ_75p_BW] TQs get 75%
  Then [Number_TQ_50p_BW] TQs get 50%
  Then [Number_TQ_25p_BW] TQs get 25%
```

### EXAMPLES

The following examples are simulations of a fabric operation in which bandwidth is allocated in accordance with embodiments of the invention.

### Example 1

Reference is now made to FIG. 5, which is a graph illustrating the effect of the bandwidth allocation interval on packet drop under varying traffic conditions. The plot was produced by simulation in accordance with an embodiment of the invention. Bandwidth assignment was asymmetric, in that uplinks can have low bandwidth, while downlinks can have high bandwidth. In the simulation, the method was carried out as described with respect to FIG. 4, using a 40 Mb buffer. Although not shown in FIG. 5, there was lower power consumption relative to conventional operation.

The effect of bandwidth allocation frequency is most pronounced under higher traffic conditions. The packet drop is significantly higher when a 30 μs interval is used (line 78) than when the allocation interval is shortened to 10 μs (line 80).

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A method for communication, comprising the steps of:
in a fabric of interconnected network switches having ingress ports and egress ports, a plurality of lanes for carrying data between the egress port of one of the switches and the ingress port of another of the switches, and queues for data awaiting transmission via the egress ports, iteratively at allocation intervals
determining current queue byte sizes of the queues of the switches;
assigning respective bandwidths to the switches according to the current queue byte sizes thereof; and
responsively to the assigned respective bandwidths disabling a portion of the lanes of the switches so as to maintain a power consumption of the fabric below a predefined limit.

2. The method according to claim 1, wherein an aggregate of the assigned respective bandwidths complies with bandwidth requirements of leaf nodes of the fabric.

3. The method according to claim 2, wherein the aggregate of the assigned respective bandwidths does not exceed throughput requirements of leaf nodes of the fabric.

4. The method according to claim 1, wherein assigning respective bandwidths comprises assigning larger bandwidths to the switches that have long queue byte sizes relative to the switches that have short queue byte sizes.

5. The method according to claim 1, wherein disabling a portion of the lanes comprises disabling fewer lanes of the switches that have long queue byte sizes relative to the switches that have short queue byte sizes.

6. The method according to claim 1, wherein uplinks through the fabric have a different bandwidth than downlinks through the fabric.

7. An apparatus, comprising:
a fabric of interconnected network switches;
a bandwidth manager connected to the switches;
ingress ports and egress ports in the switches, the ports comprising a plurality of lanes for carrying data between the egress port of one of the switches and the ingress port of another of the switches, and
a memory in the switches for storing queues for data awaiting transmission via the egress ports;
wherein the bandwidth manager is operative, iteratively at allocation intervals, for:
determining current queue byte sizes of the queues of the switches;
assigning respective bandwidths to the switches according to the current queue byte sizes thereof; and
responsively to the assigned respective bandwidths commanding a portion of the lanes of the switches to be disabled so as to maintain a power consumption of the fabric below a predefined limit.

8. The apparatus according to claim 7, wherein the egress ports comprise a plurality of serializers that are commonly served by one of the queues.

9. The apparatus according to claim 7, wherein the switches comprise leaf nodes of the fabric and an aggregate of the assigned respective bandwidths complies with bandwidth requirements of the leaf nodes.

10. The apparatus according to claim 9, wherein the aggregate of the assigned respective bandwidths does not exceed throughput requirements of the leaf nodes.

11. The apparatus according to claim 7, wherein assigning respective bandwidths comprises assigning larger bandwidths to the switches that have long queue byte sizes relative to the switches that have short queue byte sizes.

12. The apparatus according to claim 7, wherein commanding a portion of the lanes of the switches to be disabled comprises disabling fewer lanes of the switches that have long queue byte sizes relative to the switches that have short queue byte sizes.

13. The apparatus according to claim 7, wherein uplinks through the fabric have a different bandwidth than downlinks through the fabric.
